(19) United States
(12) Patent Application Publication
(10) Pub. No.: US 2024/0365966 A1
(43) Pub. Date: Nov. 7, 2024

(54) ELECTRIC TOOTHBRUSH, TOOTHPASTE BOTTLE AND HEALTH CARE DEVICE

(71) Applicant: DIMI LIFE TECHNOLOGY CO., LTD., Shenzhen (CN)

(72) Inventors: Hongwei QUAN, Shenzhen (CN); Jiajia PI, Shenzhen (CN); Rui WANG, Shenzhen (CN); Maotong JIANG, Shenzhen (CN); Haibing ZHOU, Shenzhen (CN); Lei SONG, Shenzhen (CN)

(73) Assignee: DIMI LIFE TECHNOLOGY CO., LTD., Shenzhen (CN)

(21) Appl. No.: 18/687,303

(22) PCT Filed: Aug. 19, 2022
(86) PCT No.: PCT/CN2022/113643

§ 371 Date: Feb. 28, 2024

(30) Foreign Application Priority Data
Sep. 6, 2021 (CN) 202122134473.9
Sep. 6, 2021 (CN) 202122142203.2
May 26, 2022 (CN) 202221314035.9

(51) Int. Cl. A46B 15/00; A46B 11/00; A46B 13/02; A46B 13/04; A61C 17/22

(52) U.S. Cl. CPC A46B 15/0012; A46B 11/002; A46B 13/023; A46B 13/04; A46B 15/004; A61C 17/221; A61C 17/227

(57) ABSTRACT

An electric toothbrush includes a toothbrush head and a toothbrush handle detachably coupled to each other. The toothbrush head includes a first outlet, the toothbrush handle includes an accommodation space in which a control circuitry, a connection device, a toothpaste chamber and a power generation device are provided, and the connection device is hollow. The toothpaste chamber includes a second outlet and an accommodation cavity for accommodating a toothpaste bottle provided with a first chip, first serial number information about the toothpaste bottle is stored in the first chip, the second outlet is in communication with the first outlet through the connection device, and the toothpaste chamber is provided with a first reader. The power generation device is electrically coupled to the control circuitry, and configured to enable toothpaste in the toothpaste bottle to pass through the second outlet, the connection device and the first outlet to the toothbrush head.

### CROSS-REFERENCE TO RELATED APPLICATION

This application claims priorities of the Chinese patent application No. 202122134473.9 filed on Sep. 6, 2021, the Chinese patent application No. 202122142203.2 filed on Sep. 6, 2021, and the Chinese patent application No. 202221314035.9 filed on May 26, 2022, which are incorporated herein by reference in their entireties.

### TECHNICAL FIELD

The present disclosure relates to the field of health care technology, in particular to an electric toothbrush, a toothpaste bottle and a health care device.

### BACKGROUND

Currently, during daily oral care, usually toothpaste is manually applied onto a toothbrush head, and then teeth are cleaned with a toothbrush. For some old people and children, it is very inconvenient to manually apply the toothpaste due to the insufficient ability to move. In addition, it is usually impossible for a user to identify the toothpaste efficiently. Hence, how to solve the above-mentioned problems needs to be taken into consideration.

### SUMMARY

An object of the present disclosure is to provide an electric toothbrush, a toothpaste bottle and a health care device, so as to solve the problem that an overflow of toothpaste occurs due to a residual pressure in a toothbrush handle after the use of electric toothbrush.

In one aspect, the present disclosure provides in some embodiments an electric toothbrush, including a toothbrush head and a toothbrush handle detachably coupled to each other. The toothbrush head includes a first outlet, the toothbrush handle includes an accommodation space in which a control circuitry, a connection device, a toothpaste chamber and a power generation device are provided, and the connection device is hollow. The toothpaste chamber includes a second outlet and an accommodation cavity for accommodating a toothpaste bottle, the toothpaste bottle is provided with a first chip, first serial number information about the toothpaste bottle is stored in the first chip, the second outlet is in communication with the first outlet through the connection device, and the toothpaste chamber is provided with a first reader. The power generation device is electrically coupled to the control circuitry, and configured to enable toothpaste in the toothpaste bottle to pass through the second outlet, the connection device and the first outlet to the toothbrush head. The first reader is configured to read the first serial number information from the first chip and transmit the first serial number information to the control circuitry, and the control circuitry is configured to receive the first serial number information and transmit a control signal to the power generation device in accordance with the first serial number information.

In a possible embodiment of the present disclosure, a first pipe and a propeller are further provided in the accommodation space, and the propeller is coupled to the power generation device through the first pipe and configured to push the toothpaste in the toothpaste bottle to the toothbrush head under the effect of a force applied by the power generation device.

In a possible embodiment of the present disclosure, the electric toothbrush further includes a first switch configured to control a working state of the power generation device through the control circuitry, and the first switch in a first state transmits a pushing signal to the control circuitry so that the control circuitry controls the power generation device to be in the working state in accordance with the pushing signal.

In a possible embodiment of the present disclosure, in the case that the first serial number information does not meet a first predetermined condition, the first switch is electrically decoupled from the control circuitry.

In a possible embodiment of the present disclosure, the electric toothbrush further includes an electric motor electrically coupled to the control circuitry and configured to drive the toothbrush head to vibrate.

In a possible embodiment of the present disclosure, the electric toothbrush further includes: a second chip arranged in the toothbrush head and configured to store therein second serial number information about the toothbrush head; and a second reader arranged at an end of the toothbrush handle close to the toothbrush head, and configured to read the second serial number information and transmit the second serial number information to the control circuitry, so that the control circuitry receives the second serial number information and controls a working state of the electric motor in accordance with the second serial number information.

In a possible embodiment of the present disclosure, the electric toothbrush further includes a second switch configured to control the working state of the electric motor through the control circuitry, and the second switch in a third state transmits a standby signal to the control circuitry so that the control circuitry controls the electric motor to be in a standby state in accordance with the standby signal.

In a possible embodiment of the present disclosure, in the case that the second serial number information does not meet a second predetermined condition, the second switch is electrically decoupled from the control circuitry.

In a possible embodiment of the present disclosure, a sensor assembly is further provided in the accommodation space and on an inner wall of the accommodation space, and electrically coupled to the control circuitry and the electric motor. The sensor assembly is configured to: detect a pressure applied onto the toothbrush head in a direction perpendicular to a toothbrush surface; in the case that a duration within which the detected pressure is greater than a first predetermined threshold is equal to a first predetermined duration, transmit a start signal to the control circuitry so that the control circuitry controls the electric motor to be in the working state in accordance with the start signal; and in the case that a duration within which the detected pressure is smaller than a second predetermined threshold is equal to a second predetermined duration, transmit a third stop signal to the control circuitry so that the control circuitry controls the electric motor to be in a stopping state in accordance with the third stop signal.

In a possible embodiment of the present disclosure, the sensor assembly includes a first sensing element and a second sensing element, the first sensing element is arranged on the inner wall of the accommodation space, the second sensing element is arranged on the electric motor at a position opposite to the first sensing element, and a change in a distance between the first sensing element and the second sensing element is used to indicate the pressure applied onto the toothbrush head in the direction perpendicular to the toothbrush surface.

In a possible embodiment of the present disclosure, the first sensing element is one of a pressure sensor and a positioning unit, and the second sensing element is the other of the pressure sensor and the positioning unit; and/or the first sensing element is one of a Hall sensor and a magnet, and the second sensing element is the other of the Hall sensor and the magnet.

In a possible embodiment of the present disclosure, the control circuitry is further configured to receive the second serial number information, and control a vibration frequency generated by the electric motor in accordance with the second serial number information, so that the vibration frequency generated by the electric motor corresponds to the toothpaste bottle.

In a possible embodiment of the present disclosure, the electric toothbrush further includes an electric motor cover plate fixedly coupled to the inner wall of the accommodation space and surrounding the electric motor.

In a possible embodiment of the present disclosure, a prompter is further arranged on the toothbrush handle, electrically coupled to the control circuitry, and configured to receive a prompt signal from the control circuitry and send an alarm.

In a possible embodiment of the present disclosure, the power generation device includes an air pump coupled to the second outlet through the first pipe, and configured to inject air into the toothpaste chamber through the first pipe and the second outlet, so as to apply a force generated by the air onto the propeller.

In a possible embodiment of the present disclosure, the toothpaste chamber further includes a second pipe including an air inlet and an air outlet, the air inlet forms the second outlet of the toothpaste chamber, and the propeller is arranged at the air outlet of the second pipe and forms a space surface of the accommodation cavity of the toothpaste bottle.

In a possible embodiment of the present disclosure, the electric toothbrush further includes a signal detection circuitry coupled to the air pump, and configured to transmit a fourth stop signal to the air pump in the case that an electric signal generated during the operation of the air pump is greater than a predetermined threshold, so as to enable the air pump to stop working.

In a possible embodiment of the present disclosure, the toothbrush head includes a cavity, a first end of the cavity is coupled to the first outlet, the connection device includes a hollow transmission shaft and a conduit in communication with each other, the second outlet, the conduit, the hollow transmission shaft and the cavity are in communication with each other sequentially, the hollow transmission shaft is coupled to the electric motor, and the electric motor drives bristles of the toothbrush head to vibrate through the hollow transmission shaft.

In a possible embodiment of the present disclosure, one-way valves are arranged between the conduit and the second outlet and between the first outlet and the hollow transmission shaft respectively, so as to allow the toothpaste to move in a direction from the toothpaste chamber to the toothbrush head.

In another aspect, the present disclosure provides in some embodiments a toothpaste bottle, including a container body and a first chip, the container body being provided with a liquid outlet, the first chip storing first serial number information about the toothpaste bottle. The first chip is sleeved onto the liquid outlet of the container body and fixedly coupled to the container body, or the first chip is arranged on a side wall of the container body.

In a possible embodiment of the present disclosure, the toothpaste bottle further includes a sealing element, the liquid outlet is arranged in the form of a protrusion, the sealing element is coupled to the liquid outlet, and the first chip is arranged between the sealing element and the container body.

In a possible embodiment of the present disclosure, the toothpaste bottle further includes a chip protection module sleeved onto the liquid outlet and arranged between the first chip and the sealing element.

In a possible embodiment of the present disclosure, the chip protection module includes a top cover and a side wall extending downward from an outer periphery of the top cover, an accommodation groove is defined by the top cover and the side wall, the first chip is arranged in the accommodation groove, and the sealing element is coupled to the top cover.

In a possible embodiment of the present disclosure, the toothpaste bottle further includes a base coupled to one end of the container body away from the liquid outlet.

In a possible embodiment of the present disclosure, the toothpaste bottle further includes a piston structure arranged inside the container body and including a fifth state in which the piston structure is attached to the base and a sixth state in which the piston structure is separated from the base.

In a possible embodiment of the present disclosure, a ventilation module is arranged at a center of the base, protrudes from the base toward the piston structure, and is coupled to an external power generation device. The piston structure is attached to the ventilation module in the case that a gas at a predetermined pressure is not applied by the power generation device onto the piston structure, so as to be in the fifth state, and the piston structure is separated from the ventilation module in the case that the gas at the predetermined pressure is applied by the power generation device onto the piston structure, so as to be in the sixth state.

In a possible embodiment of the present disclosure, the first chip further stores at least one of a toothpaste type, a manufacturer, efficacy mode information, or toothpaste push-out information.

In a possible embodiment of the present disclosure, the toothpaste push-out information includes a quantity of push-out times within a predetermined time period, an alarm threshold, a push-out times threshold, time for multiple push-outs, and a quantity of alarms.

In yet another aspect, the present disclosure provides in some embodiments a health care device, including the above-mentioned electric toothbrush and toothpaste bottle. The toothpaste bottle is arranged in a toothpaste chamber of the electric toothbrush.

According to the electric toothbrush in the embodiments of the present disclosure, the control circuitry reads the first serial number information about the toothpaste bottle stored in the first chip through the first reader, identifies the toothpaste bottle in accordance with the first serial number information, and transmits different control signals to the power generation device in accordance with different identification results. As a result, the toothpaste in the genuine toothpaste bottle rather than the non-genuine toothpaste bottle is used normally, so it is able to ensure the user's health and improve the user experience.

### BRIEF DESCRIPTION OF THE DRAWINGS

FIG. 1 is a sectional view of an electric toothbrush according to one embodiment of the present disclosure;

FIG. 2 is another sectional view of the electric toothbrush according to one embodiment of the present disclosure;

FIG. 3 is a sectional view of a health care device according to one embodiment of the present disclosure;

FIG. 4 is a schematic view showing a toothpaste bottle according to one embodiment of the present disclosure;

FIG. 5 is a sectional view of the toothpaste bottle in FIG. 4; and

FIG. 6 is an exploded view of the toothpaste bottle in FIG. 4.

### DETAILED DESCRIPTION

In order to make the objects, the technical solutions and the advantages of the present disclosure more apparent, the present disclosure will be described hereinafter in a clear and complete manner in conjunction with the drawings and embodiments. In the following description, specific details of configurations and assemblies are merely provided to facilitate the understanding of the present disclosure. It should be appreciated that, a person skilled in the art may make further modifications and alternations without departing from the spirit of the present disclosure. In addition, for clarification, any known function and structure will not be described hereinafter.

It should be appreciated that, such phrases as “one embodiment” and “one of the embodiments” intend to indicate that the features, structures or characteristics are contained in at least one embodiment of the present disclosure, rather than referring to a same embodiment. In addition, the features, structures or characteristics may be combined in any embodiment or embodiments in an appropriate manner.

In the embodiments of the present disclosure, such words as “in the middle of”, “longitudinal”, “lateral”, “length”, “width”, “thickness”, “on/above”, “under/below”, “front”, “back”, “left”, “right”, “vertical”, “horizontal”, “top”, “bottom”, “inside”, “outside”, “clockwise” and “counter-clockwise” may be used to indicate directions or positions as viewed in the drawings, and they are merely used to facilitate the description in the present disclosure, rather than to indicate or imply that a device or member must be arranged or operated at a specific position.

In addition, such words as “first” and “second” are merely used to differentiate different components rather than to represent any order, number or importance, i.e., they are used to implicitly or explicitly indicate that there is at least one component. Further, such a phrase as “a plurality of” is used to indicate that there are at least two, e.g., two or three, components, unless otherwise specified.

Unless otherwise specified, such words as “arrange”, “connect”, “couple” and “fix” may have a general meaning, e.g., the word “connect” may refer to fixed connection, removable connection or integral connection, or mechanical or electrical connection, or direct connection or indirect connection via an intermediate component, or communication between two components, or wired or wireless communication connection. The meanings of these words may be understood by a person skilled in the art in accordance with the practical need.

Unless otherwise defined, when a first feature is arranged on or under a second feature, the first feature is in direct contact with the second feature, or in contact with the second feature through any other feature. In addition, when the first feature is on/above the second feature, the first feature is arranged on/above, or right on/above, the second feature, or the first feature is arranged at a level higher than the second feature. When the first feature is under/below the second feature, the first feature is arranged under/below, or right under/below, the second feature, or the first feature is arranged at a level lower than the second feature.

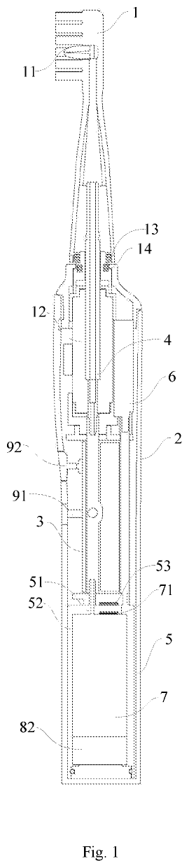

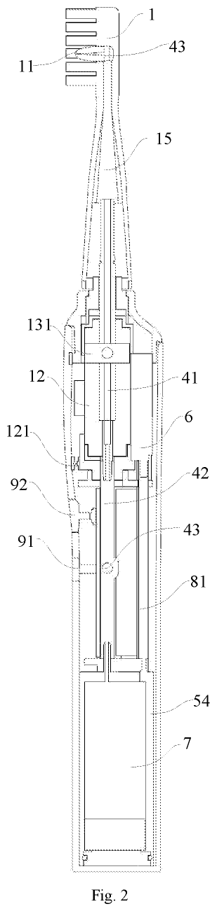

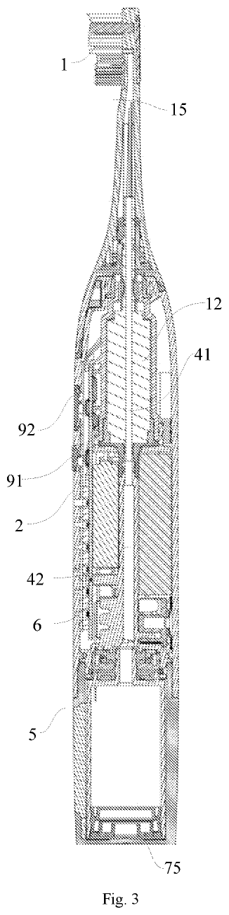

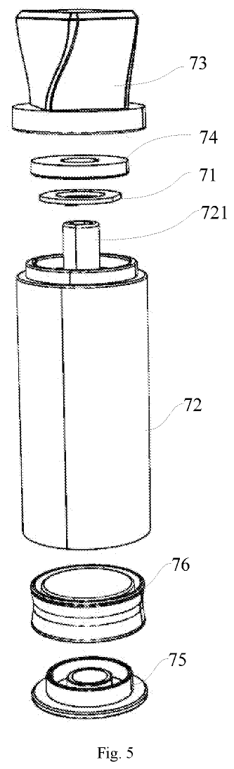

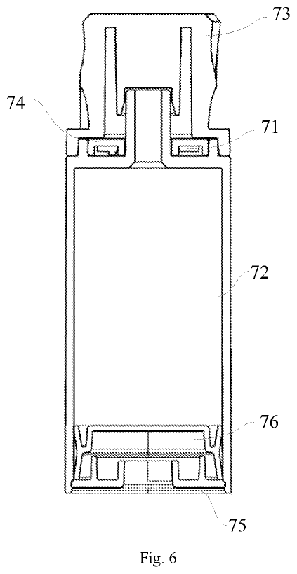

As shown in FIGS. 1 to 6, the present disclosure provides in some embodiments an electric toothbrush, which includes a toothbrush head 1 and a toothbrush handle 2 detachable coupled to each other. The toothbrush head 1 includes a first outlet 11, the toothbrush handle 2 includes an accommodation space, and a control circuitry 3, a connection device 4, a toothpaste chamber 5 and a power generation device 6 are arranged in the accommodation space. The connection device 4 is hollow.

The toothpaste chamber 5 includes a second outlet 51 and an accommodation cavity 52 for accommodating a toothpaste bottle 7, the toothpaste bottle 7 is provided with a first chip 71, first serial number information about the toothpaste bottle 7 is stored in the first chip 71, the second outlet 51 is in communication with the first outlet 11 through the connection device 4, and the toothpaste chamber 5 is provided with a first reader 53.

The power generation device 6 is electrically coupled to the control circuitry 3, and configured to enable toothpaste in the toothpaste bottle 7 to pass through the second outlet 51, the connection device 4 and the first outlet 11 to the toothbrush head 1.

The first reader 53 is configured to read the first serial number information from the first chip 71 and transmit the first serial number information to the control circuitry 3, and the control circuitry 3 is configured to receive the first serial number information and transmit a control signal to the power generation device 6 in accordance with the first serial number information.

In some embodiments of the present disclosure, the first chip 71 is arranged at a position corresponding to the first reader 53, so that the first reader 53 reads the first serial number information in the first chip 71 in a more accurate manner. In some other embodiments of the present disclosure, the first chip 71 is also arranged at a position spaced apart from the first reader 53 by a predetermined distance.

It should be appreciated that, a specific content of the first serial number information will not be particularly defined herein. Illustratively, the first serial number information is production number information about the toothpaste bottle 7.

It should be appreciated that, the first chip 71 is any chip for storing information. For example, in some embodiments of the present disclosure, the first chip 71 is a Radio Frequency Identification (RFID) chip, an internal structure and a principle of which are known in the art and thus will not be particularly defined herein.

In some embodiments of the present disclosure, the first chip 71 serves as an RFID tag (also called as electronic tag) for storing various information such as a type and a volume of the toothbrush bottle 7 and a type of the stored toothpaste. Through the first chip 71, it is able to clearly obtain the product information about the toothpaste bottle 7, determine the authenticity of the toothpaste bottle 7, and prevent the toothpaste bottle 7 from being stolen or prevent the package of the toothpaste bottle 7 from being reused.

According to the electric toothbrush in the embodiments of the present disclosure, the control circuitry 3 reads the first serial number information about the toothpaste bottle 7 stored in the first chip 71 through the first reader 53, identifies the toothpaste bottle 7 in accordance with the first serial number information, and transmits different control signals to the power generation device 6 in accordance with different identification results. As a result, the toothpaste in the genuine toothpaste bottle is used normally and the toothpaste in the non-genuine toothpaste bottle cannot be used, so it is able to ensure the user's health and improve the user experience.

In addition, when the toothpaste in the toothpaste bottle 7 is genuine, under the effect of the power generation device 6, the toothpaste in the toothpaste bottle 7 passes through the second outlet 51, the connection device 4 and the first outlet 11 to the toothbrush head 1, and finally reaches the bristles of the toothbrush head 1. As compared with a mode where the toothpaste is applied manually, in the embodiments of the present disclosure, it is able to apply the toothpaste more conveniently especially for old people or children.

It should be appreciated that, a specific mode of enabling, by the power generation device 6, the toothpaste in the toothpaste bottle 7 to pass through the second outlet 51, the connection device 4 and the first outlet 11 to the toothbrush head 1 will not be particularly defined herein. Depending on different structures of the power generation device 5, working principles of the power generation device 6 may be different too.

It should be appreciated that, in some embodiments of the present disclosure, the accommodation cavity 52 of the toothpaste chamber 5 is used to accommodate the toothpaste bottle 7. In some embodiments of the present disclosure, the toothpaste bottle 7 is detachable coupled to the toothpaste chamber 5, so as to facilitate the disassembly, installation and replacement of the toothpaste bottle 7.

In a possible embodiment of the present disclosure, a first pipe 81 and a propeller 82 are further provided in the accommodation space, and the propeller 82 is coupled to the power generation device 6 through the first pipe 81 and configured to push the toothpaste in the toothpaste bottle 7 to the toothbrush head 1 under the effect of a force applied by the power generation device 6.

It should be appreciated that, in the case that the power generation device 6 is allowed to operate, it applies a force to the propeller 82, and then the propeller 82 pushes the toothpaste in the toothpaste bottle 7 to pass through the second outlet 51, the connection device 4 and the first outlet 11 to the toothbrush head 1.

In the embodiments of the present disclosure, the first pipe 81 is configured to guide the force applied by the power generation device 6 toward the propeller 82. During the implementation, the first pipe 81 is a physical pipe structure, or a channel defined by components in the accommodation space.

It should be appreciated that, a form of the force applied by the power generation device 6 to the propeller 82 will not be particularly defined herein. For example, in some embodiments of the present disclosure, a gas at a predetermined pressure is applied by the power generation device 6 to the propeller 82, so as to push the propeller 82 to move.

In the embodiments of the present disclosure, the first pipe 81 and the propeller 82 are further arranged in the accommodation space, and the force is applied by the power generation device 6 to the propeller 82, so as to push the toothpaste in the toothpaste bottle 7 to pass through the second outlet 51, the connection device 4 and the first outlet 11 to the toothbrush head 1 in a more accurate, concentrated and efficient manner.

In a possible embodiment of the present disclosure, the electric toothbrush further includes a first switch 91 configured to control a working state of the power generation device 6 through the control circuitry 3.

The first switch 91 in a first state transmits a pushing signal to the control circuitry 3 so that the control circuitry 3 controls the power generation device 6 to be in the working state in accordance with the pushing signal.

In some embodiments of the present disclosure, a working duration of the power generation device 6 is determined by the control circuitry 3 and the first serial number information. For example, a predetermined working duration of the power generation device 6 is included in the first serial number information, or stored in the first chip 71. After a duration of the power generation device 6 in the working state reaches the predetermined working duration, the control circuitry 3 controls the power generation device 6 to stop working.

In some other embodiments of the present disclosure, the first switch 91 in a second state transmits a first stop signal to the control circuitry 3, so that the control circuitry 3 controls the power generation device 6 to stop working in accordance with the first stop signal.

The first switch 91 in different states transmits different signals to the control circuitry 3, and the control circuitry 3 controls the working state of the power generation device 6 in accordance with the signal from the first switch 91. Hence, it may be considered that the first switch 91 controls the working state of the power generation device 6 through the control circuitry 3.

For example, in some embodiments of the present disclosure, the first state is a state in which the first switch 91 is pressed down, and the second state is a state in which the first switch 91 is changed to be not pressed down. In some other embodiments of the present disclosure, the first switch 91 is pressed by a user once (short-pressed or long-pressed) so that the first switch 91 enters the first state. After a predetermined duration, the first switch 91 is set to be in the second state. In some other embodiments of the present disclosure, the first switch 91 is pressed once or multiple times within a short time period, so that the first switch 91 enters the first state. Then, the first switch 91 is pressed once or multiple times within a short time period again, so that the first switch 91 enters the second state.

For ease of understanding, the following description will be given illustratively. For example, when the electric toothbrush needs to be used by the user, the first switch 91 is in the first state, so as to transmit the pushing signal to the control circuitry 3. The control circuitry 3 transmits a power output signal to the power generation device 6, and upon the receipt of the power output signal, the power generation device 6 outputs the gas at the predetermined pressure through the first pipe 81, so as to apply a force to the propeller and move the propeller. In this way, the toothpaste in the toothpaste chamber 5 is continuously extruded to the bristles on the toothbrush head 1, so as to be in contact with teeth.

When the amount of the toothpaste on the bristles meets the user's demand, the first switch 91 is pressed by the user again so as to be in the second state. The first switch 91 transmits the first stop signal to the control circuitry 3, and the control circuitry 3 transmits a working stop signal to the power generation device 6. Upon the receipt of the working stop signal, the power generation device 6 stops applying the force to the propeller. At this time, the toothpaste in the toothpaste chamber 5 is not extruded through the propeller any more. Further, through pressing the first switch 91, a size of the force applied to the propeller, or a time for applying the force to the propeller, is adjusted by the user according to the practical need, so as to adjust the amount of the extruded toothpaste.

Through the first switch 91 and the power generation device 6, it is able for the user to push the toothpaste to the bristles conveniently with one hand.

In some embodiments of the present disclosure, the first switch 91 is long-pressed by the user so as to be maintained in a pressed-down state. During the process that the first switch 91 is maintained in a pressed-down state, the toothpaste in the toothpaste chamber 5 is continuously extruded by the propeller. When the first switch 91 is released, i.e., when the first switch 91 is not in the pressed-down state, the first switch 91 is switched from the first state to the second state, and at this time, the toothpaste in the toothpaste chamber 5 is not extruded by the propeller.

In a possible embodiment of the present disclosure, when the first serial number information does not meet a first predetermined condition, the first switch 91 is electrically decoupled from the control circuitry 3.

It should be appreciated that, the first predetermined condition will not be particularly defined herein. In some embodiments of the present disclosure, the control circuitry 3 includes a memory in which a predetermined encoding rule for the toothpaste bottle 7 is stored. Upon the receipt of the first serial number information, the control circuitry 3 determines whether the first serial number information meets the predetermined encoding rule. When the first serial number information does not meet the predetermined encoding rule, it is considered that the first serial number information does not meet the first predetermined condition.

When the first serial number information does not meet the first predetermined condition, the first switch 91 is electrically decoupled from the control circuitry 3, and at this time, it is impossible for the user to control the working state of the power generation device 6 through the first switch 91. When the first serial number information meets the first predetermined condition, the first switch 91 is electrically coupled to the control circuitry 3, and at this time, it is able for the user to control the working state of the power generation device 6 through the first switch 91.

It should be appreciated that, a method for enabling the first switch 91 to be electrically decoupled from the control circuitry 3 will not be particularly defined herein. For example, in some embodiments of the present disclosure, the first switch 91 is coupled to the control circuitry 3 through a first control switch, and the first control switch is turned on or off, so as to control the first switch 91 to be electrically coupled to, or electrically decoupled from, the control circuitry 3.

When the first serial number information does not meet the first predetermined condition, it is considered that the toothpaste in the toothpaste bottle 7 is non-genuine. At this time, even when the first switch 91 is pressed down by the user, it is still impossible to enable the power generation device 6 to be in the working state. The power generation device 6 is stopped, so it is able to prevent the non-genuine toothpaste from being used, thereby to ensure the user's health. When the first serial number information meets the first predetermined condition, it is considered that the toothpaste in the toothpaste bottle 7 is genuine, and the power generation device 6 is allowed to work, so that the toothpaste in the toothpaste bottle 7 is used by the user normally.

For example, in a possible embodiment of the present disclosure, when the first serial number information meets the first predetermined condition, the control circuitry 3 transmits a control signal to the power generation device 6, so as to allow the power generation device 6 to work. At this time, the first switch 91 is electrically coupled to the control circuitry 3. When the electric toothbrush needs to be used by the user, since the power generation device 6 receives the control signal for allowing to work from the control circuitry 3, the toothpaste in the toothpaste bottle 7 is automatically extruded by the power generation device 6 to the first outlet 11 under the effect of the control signal from the control circuitry 3, so as to facilitate the user's operation and use. When the first serial number information does not meet the first predetermined condition, the control circuitry 3 transmits a control signal to the power generation device 6, so as to enable the power generation device 6 to stop working. At this time, the first switch 91 is electrically decoupled from the control circuitry 3, and the toothpaste in the toothpaste bottle 7 does not enter the toothbrush head 1.

For example, in another possible embodiment of the present disclosure, first control information is transmitted by the control circuitry 3 to the power generation device 6 when the toothpaste in the toothpaste bottle 7 is non-genuine. Upon the receipt of the first control information, the first switch 91 is electrically decoupled from the control circuitry 3, so that the first switch 91 is electrically decoupled from the power generation device 6. At this time, no power is supplied to the power generation device 6 through the first switch 91, so the power generation device 6 does not work and the toothpaste in the toothpaste bottle 7 is not extruded to the first outlet 11. In this way, it is able to prevent the electric toothbrush from using the non-genuine toothpaste.

Second control information is transmitted by the control circuitry 3 to the power generation device 6 when the toothpaste in the toothpaste bottle 7 is genuine. Upon the receipt of the second control information, the first switch 91 is electrically coupled to the control circuitry 3, so that the first switch 91 is electrically coupled to the power generation device 6. In other words, when the toothpaste in the toothpaste bottle 7 needs to be extruded, the first switch 91 is pressed down so as to enable the first switch 91 to be electrically coupled to the power generation device 6. At this time, the power generation device 6 starts to work, so as to extrude the toothpaste in the toothpaste bottle 7 through the first outlet 11 to the bristles on the toothbrush head 1.

In the embodiments of the present disclosure, when the first serial number information does not meet the first predetermined condition, the first switch 91 is electrically decoupled from the control circuitry 3. Based on the above, when the first serial number information does not meet the first predetermined condition, it is impossible to control the working state of the power generation device 6 through the first switch 91, and it is impossible to use the toothpaste when the first serial number information does not meet the first predetermined condition. In this way, it is able to improve the security of the electric toothbrush.

In a possible embodiment of the present disclosure, the electric toothbrush further includes an electric motor 12 electrically coupled to the control circuitry 3 and configured to drive the toothbrush head 1 to vibrate.

In a possible embodiment of the present disclosure, the electric toothbrush further includes: a second chip 13 arranged in the toothbrush head 1 and configured to store therein second serial number information about the toothbrush head 1; and a second reader 14 arranged at an end of the toothbrush handle 2 close to the toothbrush head 1, and configured to read the second serial number information and transmit the second serial number information to the control circuitry 3, so that the control circuitry 3 receives the second serial number information and controls an working state of the electric motor 12 in accordance with the second serial number information.

It should be appreciated that, the second chip 13 is arranged at a position corresponding to the second reader 14, so that the second reader 14 reads the second serial number information in the second chip 13 in a more accurate manner. In some other embodiments of the present disclosure, the second chip 13 is also arranged within predefined range with the center of the second reader 14.

It should be appreciated that, a specific content of the second serial number information will not be particularly defined herein. Illustratively, the second serial number information is production serial number information about the toothpaste bottle 7.

It should be further appreciated that, the second chip 13 is any chip for storing information. For example, in some embodiments of the present disclosure, the second chip 13 is an RFID chip.

In some embodiments of the present disclosure, the second chip 13 serves as an RFID tag (also called as electronic tag) for storing various information such as a type and a manufacturer of the toothbrush head 1, efficacy mode information, vibration frequency and a type of bristles. Through the second chip 13, it is able to clearly obtain the product information about the toothbrush head 1, and determine the authenticity thereof.

The control circuitry 3 reads the second serial number information about the toothbrush head 1 stored in the second chip 13 through the second reader 14, identifies the toothbrush head 1 in accordance with the second serial number information, and transmits different control information or control signals to the electric motor 12 in accordance with different identification results. As a result, the genuine toothbrush head rather than the non-genuine one is used normally.

In addition, when the toothbrush head 1 is genuine, it is driven by the electric motor 12 to vibrate. As compared with a situation where the teeth are cleaned manually, it is able to clean the teeth through the vibration of the toothbrush head 1 in a more efficient, energy-saving and convenient manner.

In the embodiments of the present disclosure, through the second chip 13 and the second reader 14, it is able to clearly obtain the product information about the toothbrush head 1, determine the authenticity of the toothbrush head 1, and reduce the possibility of the toothbrush head 1 being stolen or reused.

In a possible embodiment of the present disclosure, the electric toothbrush further includes a second switch 92 configured to control the working state of the electric motor 12 through the control circuitry 3, and the second switch 92 in a third state transmits a standby signal to the control circuitry 3 so that the control circuitry 3 controls the electric motor 12 to be in a standby state in accordance with the standby signal.

In some embodiments of the present disclosure, a working duration of the electric motor 12 is determined by the control circuitry 3 and the second serial number information. For example, a predetermined working duration of the electric motor 12 is included in the second serial number information, or stored in the second chip 13. After a duration of the electric motor 12 in the working state reaches the predetermined working duration, the control circuitry 3 controls the electric motor 12 to stop working.

In some other embodiments of the present disclosure, the second switch 92 in a fourth state transmits a second stop signal to the control circuitry 3, so that the control circuitry 3 controls the electric motor 12 to stop working in accordance with the second stop signal.

The second switch 92 in different states transits different signals to the control circuitry 3, the control circuitry 3 controls the working state of the electric motor 12 based on the signal transmitted by the second switch. Thus, it is considered that the second switch 92 controls the working state of the electric motor 12 through the control circuitry 3.

For example, in some embodiments of the present disclosure, the second switch 92 is pressed by the user once (short-pressed or long-pressed) so that the second switch 92 enters the third state. After a predetermined duration, the second switch 92 is set to be in the fourth state. In some embodiments of the present disclosure, the third state is a state in which the second switch 92 is pressed down, and the fourth state is a state in which the second switch 92 is changed to be not pressed down. In some other embodiments of the present disclosure, the second switch 92 is pressed once or multiple times within a short time period, so that the second switch 92 enters the third state. Then, the second switch 92 is pressed once or multiple times within a short time period again, so that the second switch 92 enters the fourth state.

For ease of understanding, the following description will be given illustratively. For example, when the electric toothbrush needs to be used by the user, the second switch 92 is in a pressed-down state, so as to transmit a standby signal to the control circuitry 3. The control circuitry 3 transmits a standby operating signal to the electric motor 12, so that the electric motor 12 is in a standby state. In some embodiments of the present disclosure, after the electric motor 12 has been in the standby state for a predetermined duration, it automatically enters the working state, so as to provide a preparation time or buffer time for the user. The predetermined duration may be any duration set according to the practical need, and in the case that the predetermined duration is short, it may be considered that the electric motor 12 directly enters the working state. In some other embodiments of the present disclosure, when the electric motor 12 is in the standby state, a start signal needs to be applied to the electric motor 12 so as to switch the electric motor 12 from the standby state into a start state.

After the tooth brushing, in the case that the second switch 92 is changed to be not pressed down or the duration of the second switch 92 in the third state reaches the predetermined duration, the second switch 92 is automatically switched to be in the fourth state, and transmits a second stop signal to the control circuitry 3. Upon the receipt of the second stop signal, the control circuitry 3 controls the electric motor 12 to stop working. Further, through pressing the second switch 92, the working duration and/or frequency of the electric motor 12 are adjusted by the user according to the practical need, so as to adjust a vibration duration and/or a vibration frequency of the toothbrush head 1.

Through the second switch 92 and the electric motor 12, it is able for the user to control the vibration of the toothbrush head 1 conveniently with one hand.

In some embodiments of the present disclosure, the second switch 92 is long-pressed by the user so as to be maintained in the pressed-down state. During the process that the second switch 92 is maintained in the pressed-down state, the toothbrush head 1 vibrates continuously under the effect of the electric motor 12. When the second switch 92 is released, i.e., when the second switch 92 is not in the pressed-down state, the second switch 92 is switched from the third state to the fourth state, and at this time, the toothbrush head 1 stops vibrating.

It should be appreciated that, the first switch 91 and the second switch 92 are used separately, i.e., the state of the first switch 91 is independent of the state of the second switch 92, and the states of the first switch 91 and the second switch 92 are controlled separately by the user.

In a possible embodiment of the present disclosure, when the second serial number information does not meet a second predetermined condition, the second switch 92 is electrically decoupled from the control circuitry 3.

It should be appreciated that, the second predetermined condition will not be particularly defined herein. For example, in some embodiments of the present disclosure, the control circuitry 3 includes a memory in which a predetermined encoding rule for the toothbrush head is stored. Upon the receipt of the second serial number information, the control circuitry 3 determines whether the second serial number information meets the predetermined encoding rule for the toothbrush head. When the second serial number information does not meet the predetermined encoding rule, it is considered that the second serial number information does not meet the second predetermined condition.

When the second serial number information does not meet the second predetermined condition, the second switch 92 is electrically decoupled from the control circuitry 3, and at this time, it is impossible for the user to control the working state of the electric motor 12 through the second switch 92. When the second serial number information meets the second predetermined condition, the second switch 92 is electrically coupled to the control circuitry 3, and at this time, it is able for the user to control the working state of the electric motor 12 through the second switch 92.

It should be appreciated that, a method for enabling the second switch 92 to be electrically decoupled from the control circuitry 3 will not be particularly defined herein. For example, in some embodiments of the present disclosure, the second switch 92 is coupled to the control circuitry 3 through a second control switch, and the second control switch is turned on or off, so as to control the second switch 92 to be electrically coupled to, or electrically decoupled from, the control circuitry 3.

When the second serial number information does not meet the second predetermined condition, it is considered that the toothbrush head is non-genuine. At this time, even when the second switch 92 is pressed down by the user, it is still impossible to enable the electric motor 12 to be in the standby state or working state. The electric motor 12 is stopped, so it is able to prevent the non-genuine toothbrush head from being used, thereby to ensure the user's health. When the second serial number information meets the second predetermined condition, it is considered that the toothbrush head 1 is genuine, and the electric motor 12 is allowed to work, so that the toothbrush head 1 is used by the user normally.

For example, in a possible embodiment of the present disclosure, when the second serial number information meets the second predetermined condition, the control circuitry 3 transmits a control signal to the electric motor 12, so as to allow the electric motor 12 to work. At this time, the second switch 92 is electrically coupled to the control circuitry 3. When the electric toothbrush needs to be used and the toothpaste has already existed on the bristles of the toothbrush head 1, the working state of the electric motor 12, which has received the control signal from the control circuitry 3, is controlled through the second switch 92, so as to drive the toothbrush head 1 to vibrate for tooth brushing. When the second serial number information does not meet the second predetermined condition, the control circuitry 3 transmits a control signal to the electric motor 12, so as to enable the electric motor 12 to stop working. At this time, the second switch 92 is electrically decoupled from the control circuitry 3, and it is impossible to use the toothbrush head 1.

For example, in another possible embodiment of the present disclosure, third control information is transmitted by the control circuitry 3 to the electric motor 12 when the toothbrush head 1 is non-genuine. Upon the receipt of the third control information, the second switch 92 is electrically decoupled from the control circuitry 3, so that the second switch 92 is electrically decoupled from the electric motor 12. At this time, no power is supplied to the electric motor 12 through the second switch 92, so the electric motor 12 does not work. In this way, it is able to prevent the electric toothbrush from using the non-genuine toothbrush head.

Fourth control information is transmitted by the control circuitry 3 to the electric motor 12 when the toothbrush head 1 is genuine. Upon the receipt of the fourth control information, the second switch 92 is electrically coupled to the control circuitry 3, so that the second switch 92 is electrically coupled to the electric motor 12. In other words, when the toothbrush head I needs to be used, the second switch 92 is pressed down so as to enable the second switch 92 to be electrically coupled to the electric motor 12. At this time, the electric motor 12 starts to work, so as to drive the genuine toothbrush head 1 to vibrate normally.

In the embodiments of the present disclosure, when the second serial number information does not meet the second predetermined condition, the second switch 92 is electrically decoupled from the control circuitry 3. Based on the above, when the second serial number information does not meet the second predetermined condition, it is impossible to control the working state of the electric motor 12 through the second switch 92, and it is impossible to use the toothbrush head 1 when the second serial number information does not meet the second predetermined condition. In this way, it is able to improve the security of the electric toothbrush.

In some embodiments of the present disclosure, when the toothpaste is genuine, the first switch 91 is electrically coupled to the power generation device 6, so as to control the working state of the power generation device 6 through the first switch 91, thereby to enable the toothpaste in the toothpaste bottle 7 to reach the bristles of the toothbrush head 1. When the toothbrush head 1 is genuine, the second switch 92 is electrically coupled to the electric motor 12, so as to control the working state of the electric motor 12 through the second switch 92, thereby to enable the electric motor 12 to drive the toothbrush head 1 to vibrate for tooth brushing.

When the toothpaste in the toothpaste bottle 7 is non-genuine or there is no toothpaste bottle 7 in the toothpaste chamber 5 (i.e., the control circuitry 3 fails to receive the first serial number information) and the toothbrush head 1 is genuine, the toothbrush head rather than the toothpaste bottle 7 is used normally. In this case, the toothpaste is applied manually to the bristles of the toothbrush head 1, and then the electric motor 12 is started for the tooth brushing.

In the case that the toothpaste in the toothpaste bottle 7 is genuine but the toothbrush head 1 is non-genuine, in some cases, the toothpaste in the toothpaste bottle 7 is incapable of being extruded to the bristles of the toothbrush head 1, and the electric motor 12 is incapable of being started. In some other cases, the toothpaste in the toothpaste bottle 7 is capable of being extruded to the bristles of the toothbrush head 1, and the electric motor 12 is capable of being started and operating in accordance with the first serial number information about the toothpaste bottle 7 or a mode set by the first chip 71, but incapable of operating in accordance with the second serial number information about the toothbrush head 1 or a mode set by the second chip 13.

In a possible embodiment of the present disclosure, a sensor assembly 121 is further provided in the accommodation space and on an inner wall of the accommodation space, and electrically coupled to the control circuitry 3 and the electric motor 12. The sensor assembly 121 is configured to: detect a pressure applied onto the toothbrush head 1 in a direction perpendicular to a toothbrush surface; in the case that a duration within which the detected pressure is greater than a first predetermined threshold is equal to a first predetermined duration, transmit a start signal to the control circuitry 3 so that the control circuitry 3 controls the electric motor 12 to be in the working state in accordance with the start signal; and in the case that a duration within which the detected pressure is smaller than a second predetermined threshold is equal to a second predetermined duration, transmit a third stop signal to the control circuitry 3 so that the control circuitry 3 controls the electric motor 12 to be in a stopping state in accordance with the third stop signal.

It should be appreciated that, values of the first predetermined threshold and the first predetermined duration will not be particularly defined herein. Here, the first predetermined threshold is a default pressure threshold at which the electric toothbrush vibrates, and the first predetermined duration is set according to the practical need.

For example, when the duration within which the pressure detected by the sensor assembly 121 is greater than the first predetermined threshold is 1 s to 2 s, the control circuitry 3 is triggered to transmit the start signal. At this time, the control circuitry 3 controls, through the electric motor 12, the toothbrush head 1 to vibrate. In other words, the tooth brushing is started when the duration within which the pressure applied to the toothbrush head 1 exceeds a threshold is equal to a certain value.

It should be appreciated that, values of the second predetermined threshold and the second predetermination duration will not be particularly defined herein. Here, the second predetermined threshold is a default critical value at which the electric toothbrush stops vibrating, and the second predetermined duration is set according to the practical need.

For example, when the duration within which the pressure detected by the sensor assembly 121 is smaller than the second predetermined threshold is 1 s to 2 s, the control circuitry 3 is triggered to transmit the third stop signal. At this time, the control circuitry 3 controls, through the electric motor 12, the toothbrush head 1 to stop vibrating. In other words, the tooth brushing is ended when the duration within which the pressure applied to the toothbrush head 1 is smaller than a threshold is equal to a certain value.

For ease of understanding, the following description will be given illustratively. In use, when the toothbrush head 1 is in contact with the teeth, the sensor assembly 121 detects the pressured applied onto the toothbrush head 1 in the direction perpendicular to the toothbrush surface. When the duration within which the detected pressure is greater than the first predetermined threshold is equal to the first predetermined duration, the control circuitry 3 transmits the start signal, so as to start the electric motor 12 and drive the toothbrush head I to vibrate for the tooth brushing. When the toothbrush head 1 moves away from the teeth and the duration within which the detected pressure is smaller than the second predetermined threshold is equal to the second predetermined duration, the control circuitry 3 transmits the third stop signal, so as to stop the electric motor 12. At this time, the toothbrush head 1 stops vibrating, and the tooth brushing is ended.

In the embodiments of the present disclosure, the sensor assembly 121 detects the pressured applied onto the toothbrush head 1 in the direction perpendicular to the toothbrush surface, transmits the start signal to the control circuitry 3 when the duration within which the detected pressure is greater than the first predetermined threshold is equal to the first predetermined duration, and transmits the third stop signal to the control circuitry 3 when the duration within which the detected pressure is smaller than the second predetermined threshold is equal to the second predetermined duration. In this way, it is able to prevent the toothpaste from sputtering when the toothbrush head moves out of the mouth unexpectedly, and prevent the electric toothbrush from vibrating due to unintended activation.

It should be appreciated that, a specific structure of the sensor assembly 12 will not be particularly defined herein. In a possible embodiment of the present disclosure, the sensor assembly 121 includes a first sensing element and a second sensing element. The first sensing element is arranged on the inner wall of the accommodation space, the second sensing element is arranged on the electric motor 12 at a position opposite to the first sensing element, and a change in a distance between the first sensing element and the second sensing element is used to indicate the pressure applied onto the toothbrush head 1 in the direction perpendicular to the toothbrush surface.

In the embodiments of the present disclosure, when the toothbrush head 1 is in contact with the teeth, the pressure applied onto the toothbrush head 1 in the direction perpendicular to the toothbrush surface is determined through detecting the change in the distance between the first sensing element and the second sensing element, so it is able for the sensor assembly 121 to detect the pressure accurately and conveniently.

In a possible embodiment of the present disclosure, the first sensing element is one of a pressure sensor and a positioning unit, and the second sensing element is the other of the pressure sensor and the positioning unit.

One of the pressure sensor and the positioning unit is arranged on the inner wall of the accommodation space, and the other is arranged on the electric motor 12. For example, in some embodiments of the present disclosure, the pressure sensor is arranged on an inner wall of a toothbrush housing, and the positioning unit is fixed onto the electric motor 12.

In another possible embodiment of the present disclosure, the first sensing element is one of a Hall sensor and a magnet, and the second sensing element is the other of the Hall sensor and the magnet.

One of the Hall sensor and the magnet is arranged on the inner wall of the accommodation space, and the other is arranged on the electric motor 12. Identically, the Hall sensor is arranged on the inner wall of the toothbrush housing, and the magnet is fixed onto the electric motor 12.

In some embodiments of the present disclosure, the sensor assembly 121 includes the pressure sensor, the positioning unit, the Hall sensor and the magnet. The pressure sensor and the positioning unit, as a group, are used to detect the pressure applied onto the toothbrush head 1 in the direction perpendicular to the toothbrush surface, so as to obtain a first detection value. The Hall sensor and the magnet, as a group, are used to detect the pressure applied onto the toothbrush head 1 in the direction perpendicular to the toothbrush surface, so as to obtain a second detection value. A final detection value is determined in accordance with the first detection value and the second detection value.

It should be appreciated that, when a force is applied onto the toothbrush head 1, a distance between the Hall sensor and the magnet of the electric toothbrush changes. When the magnet approaches the Hall sensor to a certain distance, an output signal of the Hall sensor changes, and the change in the output signal is detected by a main control board.

When the change in the output signal from the Hall sensor is detected by the main control board, the tooth brushing is considered to be started, so the electric motor 12 drives the toothbrush head 1 to vibrate. When the toothbrush moves out of the mouth, the magnet moves away from the Hall sensor due to a change in the stress, so the output signal from the Hall sensor changes again. After the main control board has detected the change in the output signal, the tooth brushing is considered to be stopped, so the electric motor 12 is stopped, and the toothbrush head stops vibrating. In this way, it is able to prevent the toothpaste from sputtering when the toothbrush head moves out of the mouth unexpectedly.

In a possible embodiment of the present disclosure, the control circuitry 3 is further configured to receive the second serial number information, and control a vibration frequency generated by the electric motor 12 in accordance with the second serial number information, so that the vibration frequency generated by the electric motor 12 corresponds to the toothpaste bottle 7.

It should be appreciated that, depending on different types of the toothpaste bottles 7 in the toothpaste chamber 5 (the types of the toothpaste in the toothpaste bottles 7), different vibration frequencies are generated by the electric motor 12, so as to drive the toothbrush head 1 to vibrate at a corresponding vibration frequency, thereby to meet the user's requirement. For example, when the toothpaste bottle 7 is of a first type, a vibration frequency of 200 Hz is generated by the electric motor 12, so as to drive the toothbrush head 1 to vibrate at the vibration frequency of 200 Hz. When the toothpaste bottle 7 is of a second type, a vibration frequency of 220 Hz is generated by the electric motor 12, so as to drive the toothbrush head 1 to vibrate at the vibration frequency of 220 Hz. In some embodiments of the present disclosure, information about the types of the toothpaste bottles 7 is stored in the first chip 71.

In the embodiments of the present disclosure, upon the receipt of the first serial number information from the first reader 53, the control circuitry 3 transmits the corresponding control signal to the electric motor 12, so that the vibration frequency of the electric motor 12 matches the toothpaste bottle 7. In this way, for the genuine toothpaste, it is able to drive the toothbrush head 1 to vibrate at an appropriate vibration frequency, thereby to achieve an optimum tooth brushing effect.

In a possible embodiment of the present disclosure, the electric toothbrush further includes an electric motor cover plate 131 fixedly coupled to the inner wall of the accommodation space and surrounding the electric motor 12.

It should be appreciated that, the electric motor 12 is a vibrating member, and when the electric motor 12 operates for a too long time period or vibrates excessively, a position of the electric motor 12 in the accommodation space may change.

In the embodiments of the present disclosure, when the electric motor cover plate 131 is fixedly coupled to the inner wall of the accommodation space, it is able to improve the fixing stability of the electric motor cover plate 131. In addition, when the electric motor cover plate 131 surrounds the electric motor 12, it is able to fix the electric motor 12 and prevent the electric motor 12 from moving. In this way, it is able to improve the quality and security of the electric toothbrush.

In a possible embodiment of the present disclosure, a prompter is further arranged on the toothbrush handle 2, electrically coupled to the control circuitry 3, and configured to receive a prompt signal from the control circuitry 3 and send an alarm.

It should be appreciated that, the prompter is an indicator or a buzzer. The prompt signal is transmitted by the control circuitry 3 to the prompter when the toothbrush head 1 is non-genuine or the toothpaste in the toothpaste bottle 7 is non-genuine. Upon the receipt of the prompt signal, the prompter sends an alarm. For example, the indicator flashes in red or in the form of waterfall lights in a certain direction, or the buzzer beeps at a first frequency.

The prompt signal is also transmitted by the control circuitry to the prompter when the toothbrush head 1 is genuine and the quantity of times the toothbrush head 1 is used reaches a first predetermined value, or when the toothpaste in the toothpaste bottle 7 is genuine and the quantity of times the toothpaste is used reaches a second predetermined value. In this case, the indicator flashes in yellow or in the form of waterfall lights in a certain direction, or the buzzer beeps at a second frequency. In this way, through the prompter, it is able to prompt the user to replace the toothbrush head 1 or the toothpaste bottle 7 in time, thereby to improve the user experience.

For example, when the toothpaste in the toothpaste bottle 7 is genuine, the first serial number information is compared with an existing production number of the toothpaste bottle 7 stored in the memory. When the first serial number information has existed in the memory, it means that the toothpaste was used by the electric toothbrush before, and when the first serial number information is not stored in the memory, it means that the toothpaste is used by the electric toothbrush for the first time, and the first serial number information is recorded in the memory. When the electric toothbrush is started each time, the quantity of times the first serial number information about the toothpaste is used is incremented by one in the memory, so as to record the quantity of times.

For example, when the toothbrush head 1 is genuine, the second serial number information is compared with an existing production number of the toothbrush head 1 stored in the memory. When the second serial number information has existed in the memory, it means that the toothbrush head I was used by the electric toothbrush before, and when the second serial number information is not stored in the memory, it means that the toothbrush head 1 is used by the electric toothbrush for the second time, and the second serial number information is recorded in the memory. When the electric toothbrush is started each time, the quantity of times the second serial number information about the toothbrush head 1 is used is incremented by one in the memory, so as to record the quantity of times.

In the embodiments of the present disclosure, the prompter is further provided on the toothbrush handle 2 and electrically coupled to the control circuitry 3, so as to receive the prompt signal from the control circuitry 3 and send an alarm. Through the prompter, it is able for the user to determine an operating situation of the electric toothbrush and perform corresponding processings in time.

In a possible embodiment of the present disclosure, the power generation device 6 includes an air pump coupled to the second outlet 51 through the first pipe 81, and configured to inject air into the toothpaste chamber 5 through the first pipe 81 and the second outlet 51, so as to apply a force onto the propeller 82.

It should be appreciated that, during the operation, the air pump generates air and inject air into the toothpaste chamber 5 through the first pipe 81 and the second outlet 51, so as to apply a force onto the propeller 82, thereby to enable the propeller 82 to move.

In a possible embodiment of the present disclosure, the toothpaste chamber 5 further includes a second pipe 54 including an air inlet and an air outlet, the air inlet forms the second outlet 51 of the toothpaste chamber 5, and the propeller 82 is arranged at the air outlet of the second pipe 54 and forms a space surface of the accommodation cavity 52 of the toothpaste bottle 7.

It should be appreciated that, when the propeller 82 forms the space surface of the accommodation space for the toothpaste, the accommodation space is separated from the outside under the space surface. The propeller 82 is arranged at the air outlet of the second pipe 54, so a force is applied onto the propeller 82 due to air from the air outlet of the second pipe 54. In this way, it is able to move the propeller 82, thereby to push the toothpaste in the toothpaste chamber 5 through the second outlet 51 to the toothbrush head 1.

In a possible embodiment of the present disclosure, the electric toothbrush further includes a signal detection circuitry coupled to the air pump, and configured to transmit a fourth stop signal to the air pump in the case that an electric signal generated during the operation of the air pump is greater than a predetermined threshold, so as to enable the air pump to stop working.

It should be appreciated that, the electric signal generated during the operation of the air pump is a current signal, a voltage signal or a resistance signal.

In some embodiments of the present disclosure, when an air pressure generated during the operation of the air pump is greater than a threshold, the signal detection circuitry transmits the fourth stop signal to the air pump, so as to enable the air pump to stop working. In some other embodiments of the present disclosure, when a relevant parameter of the air pump during the operation is greater than a predetermined threshold, the signal detection circuitry transmits the fourth stop signal to the air pump, so as to enable the air pump to stop working. Here, the relevant parameter is any parameter for representing a working state of the air pump.

It should be appreciated that, the toothpaste in the toothpaste bottle 7 is consumed continuously along with an increase in uses. When the toothpaste has been used out but the air pump is still started, the propeller 82 may not be displaced under the effect of the force applied by the air pump. However, at this time, the toothpaste chamber 5 is rapidly filled up with air, and thereby an air pressure in the toothpaste chamber 5 increases rapidly. In order to inject air into the toothpaste chamber 5 continuously, an electric motor of the air pump needs to operate at larger power. A power supply voltage is constant, so an operating current of the electric motor of the air pump increases. When the operating current is greater than a predetermined current value, it is considered that the toothpaste in the toothpaste bottle 7 has been used out.

In the embodiments of the present disclosure, the signal detection circuitry is used to transmit the fourth stop signal to the air pump when the electric signal generated during the operation of the air pump is greater than the predetermined threshold. In this way, it is able to prevent the air pump or any other member of the electric toothbrush from being damaged, thereby to prolong a service life of the electric toothbrush.

In a possible embodiment of the present disclosure, the toothbrush head 1 includes a cavity 15, a first end of the cavity 15 is coupled to the first outlet 11, the connection device 4 includes a hollow transmission shaft 41 and a conduit 42 in communication with each other, the second outlet 51, the conduit 42, the hollow transmission shaft 41 and the cavity 15 are in communication with each other sequentially, the hollow transmission shaft 41 is coupled to the electric motor 12, and the electric motor 12 drives bristles of the toothbrush head 1 to vibrate through the hollow transmission shaft 41.

It should be appreciated that, the connection device 4 is in communication with the toothpaste chamber 5 and the toothbrush head 1. The connection device 4 passes through the electric motor 12, and an output shaft of the electric motor 12 is a hollow transmission shaft. To be specific, the connection device 4 is coupled to the hollow transmission shaft, so as to pass through the electric motor 12, thereby to reduce a volume of the electric toothbrush.

In the embodiments of the present disclosure, the second outlet 51 is coupled to the first outlet 11 through the connection device 4. The connection device 4 is hollow, and it includes the hollow transmission shaft 41 and the conduit 42. Under the effect of the propeller, the toothpaste moves through the second outlet 51, the conduit 42, the hollow transmission shaft 41 and the first outlet 11 into the cavity 15 of the toothbrush head 1. In this way, it is able to reduce the volume of the electric toothbrush, and facilitate the delivery of the toothpaste to the toothbrush head 1.

In a possible embodiment of the present disclosure, one-way valves 43 are arranged between the conduit 42 and the second outlet 51 and between the first outlet 11 and the hollow transmission shaft 41, so as to allow the toothpaste to move in a direction from the toothpaste chamber 5 to the toothbrush head 1.

For example, a first one-way valve is arranged between the first outlet 11 and the hollow transmission shaft 41, so as to allow the toothpaste to move in a direction from the hollow transmission shaft 41 to the first outlet 11. The first one-way valve is arranged inside the toothpaste head 1.

It should be appreciated that, through the first one-way valve between the first outlet 11 and the hollow transmission shaft 41, it is able to prevent the toothpaste at the bristles from flowing back into the hollow transmission shaft 41, thereby to prevent the user experience from being adversely affected.

For example, a second one-way valve is arranged between the conduit 42 and the second outlet 51, so as to allow the toothpaste to move in a direction from the second outlet 51 to the conduit 42.

It should be appreciated that, through the second one-way valve between the conduit 42 and the second outlet 51, it is able to prevent the toothpaste in the conduit 42 from flowing back into the toothpaste bottle 7. In addition, the toothpaste bottle 7 is coupled to the conduit 42 through the second one-way valve, so as to fix the toothpaste bottle 7.

In the embodiments of the present disclosure, the one-way valve 43 is arranged between the first outlet 11 and the hollow transmission shaft 41, so as to prevent the toothpaste at the bristles from flowing back into the connection device 4, thereby to prevent the user experience from being adversely affected. The one-way valve 43 is arranged between the conduit 42 and the second outlet 51, so as to prevent the toothpaste in the conduit 42 from flow back into the toothpaste chamber 5, and enable the toothpaste chamber 5 to be coupled to the conduit 42.

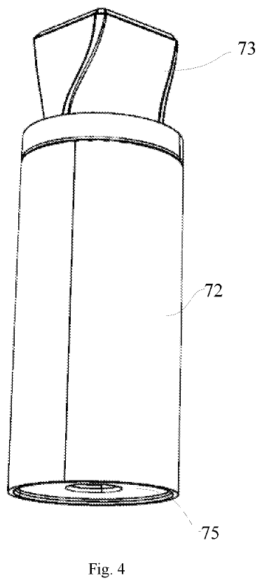

As shown in FIGS. 4 to 6, the present disclosure provides in some embodiments a toothpaste bottle 7, which includes a container body 72 and a first chip 71. The container body 72 is provided with a liquid outlet 721, and the first chip 71 stores therein first serial number information about the toothpaste bottle 7. The first chip 71 is sleeved onto the liquid outlet 721 of the container body 72 and fixedly coupled to the container body 72, or the first chip 71 is arranged on a side wall of the container body 72.

It should be appreciated that, the first chip 71 and the first serial number information may refer to those mentioned hereinabove, and thus will not be particularly defined herein.

In the embodiments of the present disclosure, the first chip 71 is arranged in two modes. In one mode, the first chip 71 is sleeved onto the liquid outlet 721 of the container body 72, and fixedly coupled to the container body 72, so as to protect the first chip 71. When the liquid outlet 721 cooperates with a predetermined liquid inlet, it is able to directly identify information about the container body 72, and it is unnecessary to identify the first chip 71 with any external detection device. In another mode, the first chip 71 is arranged on the side wall of the container body 72, it is able to identify the first chip 71 with an external detection device. In the above-mentioned two modes, it is able to clearly obtain the product information about the toothpaste bottle 7, determine the authenticity of the toothpaste bottle 7, and prevent the toothpaste bottle from being stolen or reused.

In a possible embodiment of the present disclosure, the toothpaste bottle 7 further includes a sealing element 73, the liquid outlet 721 is arranged in the form of a protrusion, the sealing element 73 is coupled to the liquid outlet 721, and the first chip 71 is arranged between the sealing element 73 and the container body 72.

In the embodiments of the present disclosure, the liquid outlet 721 is arranged in the form of a protrusion, and a specific shape of the liquid outlet 721 will not be particularly defined herein. For example, in some embodiments of the present disclosure, the liquid outlet 721 is of a cone-like shape, and in some other embodiments of the present disclosure, a cross section of the liquid outlet 721 is a rectangle.

It should be appreciated that, the sealing element 73 is coupled to the liquid outlet 721, so it may be considered that the sealing element 73 is adapted to the liquid outlet 721. In some embodiments of the present disclosure, the sealing element 73 is adapted to a protruding portion of the liquid outlet 721.

For example, in some embodiments of the present disclosure, the liquid outlet 721 is of a cylindrical shape. The liquid outlet 721 is hollow, and an outer surface of the liquid outlet 721 is threaded, so that the sealing element 73 is in threaded connection with the liquid outlet 721. The first chip 71 is of an annular structure, sleeved onto the cylindrical liquid outlet 721, and arranged close to the container body 72. The sealing element 73 is in the form of a sealing cover. Through the threaded connection between the sealing element 73 and the liquid outlet 721, it is able to ensure the hermeticity of the container body 72.

Of course, apart from the threaded connection, the sealing element 73 is coupled to the liquid outlet 721 in any other modes according to the practical need.

In the embodiments of the present disclosure, the toothpaste bottle 7 further includes the sealing element 73 coupled to the liquid outlet 721, the liquid outlet 721 is arranged in the form of a protrusion, and the first chip 71 is arranged between the sealing element 73 and the container body 72. Through the sealing element 73, it is able to improve the hermeticity of the container body 72.

In a possible embodiment of the present disclosure, the toothpaste bottle 7 further includes a chip protection module 74 sleeved onto the liquid outlet 721 and arranged between the first chip 71 and the sealing element 73.

It should be appreciated that, a specific structure of the chip protection module 74 will not be particularly defined herein. In a possible embodiment of the present disclosure, the chip protection module 74 includes a top cover and a side wall extending downward from an outer periphery of the top cover, an accommodation groove is defined by the top cover and the side wall, the first chip 71 is arranged in the accommodation groove, and the sealing element 73 is coupled to the top cover.

Here, the top cover and the side wall extending downward from the outer periphery of the top cover form a cap-like member (with the accommodation groove for receiving an object). The cap-like chip protection module 74 is sleeved onto the liquid outlet 721, and the first chip 71 is received in the accommodation groove, and the sealing element 73 is coupled to the top cover, so as to protect the first chip 71 through the chip protection module 74.

In a possible embodiment of the present disclosure, the toothpaste bottle 7 further includes a base 75 coupled to one end of the container body 72 away from the liquid outlet 721. Here, the base 75 is used to seal the end of the container body 72 away from the liquid outlet 721.

In some embodiments of the present disclosure, the base 75 is detachably coupled to the end of the container body 72 away from the liquid outlet 721. For example, the base 75 is in threaded connection with the container body 72.

In a possible embodiment of the present disclosure, the toothpaste bottle 7 further includes a piston structure 76 arranged inside the container body 72 and including a first state in which the piston structure 76 is attached to the base 75 and a second state in which the piston structure 76 is separated from the base 75.

In the embodiments of the present disclosure, the piston structure 76 moves inside the container body 72, so as to be switched between the first state in which the piston structure 76 is attached to the base 75 and the second state in which the piston structure 76 is separated from the base 75. In some embodiments of the present disclosure, the first state is a state in which the toothpaste in the container body 72 is not used and the piston structure 76 is coupled to the base 75.

In a possible embodiment of the present disclosure, a ventilation module is arranged at a center of the base 75, protrudes from the base toward the piston structure 76, and is coupled to an external power generation device 6. The piston structure 76 is attached to the ventilation module in the case that a gas at a predetermined pressure is not applied by the power generation device 6 onto the piston structure 76, so as to be in the first state, and the piston structure 76 is separated from the ventilation module in the case that the gas at the predetermined pressure is applied by the power generation device 6 onto the piston structure 76, so as to be in the second state.

The ventilation module is arranged at the center of the base 75, protrudes from the base toward the piston structure 76, and is coupled to the external power generation device 6. When the gas at the predetermined pressure is not applied by the power generation device 6 onto the piston structure 76, the piston structure 76 is coupled to the ventilation module so as to be in the first state. When the gas at the predetermined pressure is applied by the power generation device 6 onto the piston structure 76, the piston structure 76 is separated from the ventilation module so as to be in the second state.

It should be appreciated that, a specific structure of the external power generation device 6 will not be particularly defined herein. For example, the power generation device 6 is an air pump. When the gas at the predetermined pressure is applied by the power generation device 6 to the ventilation module, i.e., in a direction from the base 75 to the piston structure 76, it is able to push the piston structure 76 to move inside the container body 72, thereby to discharge a liquid.

In the embodiments of the present disclosure, when the ventilation module is arranged at the center of the base 75 in such a manner as to protrude toward the piston structure 76, it is able for the piston structure 76 to be coupled firmly to the base 75, thereby to prevent the base 75 from being separated from the container body 72 under the effect of the piston structure 76.

In a possible embodiment of the present disclosure, the first chip 71 further stores at least one of a toothpaste type, a manufacturer, efficacy mode information, or toothpaste push-out information.

In a possible embodiment of the present disclosure, the toothpaste push-out information includes the quantity of push-outs times within a predetermined time period, an alarm threshold, a push-out times threshold, the time of multiple push-out, and the quantity of alarms.

In some embodiments of the present disclosure, the efficacy mode information is determined in accordance with toothpaste viscosity, toothpaste effect and toothpaste liquidity. In some embodiments of the present disclosure, the toothpaste effect includes caries prevention, breath freshening, teeth whitening, gingiva protection, teeth stain removal, anti-irritation, etc. The efficacy mode information includes a vibration mode and a vibration frequency corresponding to the toothpaste, a duty ratio of a driving signal for the electric motor, and a state of the prompter.

For example, in some embodiments of the present disclosure, the vibration mode includes a frequency-constant vibration mode and a frequency-variable vibration mode. To be specific, in the frequency-constant vibration mode, a vibration frequency of the toothbrush head 1 is constant during the tooth brushing, and in the frequency-variable vibration mode, the vibration frequency of the toothbrush head 1 changes at time intervals during the operation.

In some embodiments of the present disclosure, the vibration mode further includes a power-on slow vibration mode in which the vibration frequency of the toothbrush head 1 increases slowly to a predetermined frequency after the electric toothbrush is powered on.

In some embodiments of the present disclosure, a correspondence between an efficacy mode and the vibration mode, the duty ratio of the driving signal for the electric motor and the state of the propter is predefined and stored. Names or indices of the efficacy modes are stored in the first chip 71, and the vibration mode, the duty ratio of the driving signal for the electric signal and the state of the prompter corresponding to each efficacy mode are stored at the control circuitry 3.

During the implementation, the toothbrush handle 2 is further provided with a pushing state indicator for indicating a pushing state of the toothpaste. For example, the pushing state indicator is electrically coupled to the control circuitry 3. When the control circuitry 3 controls the power generation device to push the toothpaste, the pushing state indicator is always on, flickers, or flashes in the form of waterfall lights. When the pushing of the toothpaste is stopped, the pushing state indicator is turned off.

In some embodiments of the present disclosure, the toothbrush handle 2 is further provided with a mode indicator for indicating a current efficacy mode. For example, each efficacy mode corresponds to one mode indicator, and in use, the mode indicator corresponding to the current efficacy mode is always on, and the other mode indicators are turned off.

The present disclosure further provides in some embodiments a health care device, which includes the above-mentioned electric toothbrush and toothpaste bottle 7. The toothpaste bottle 7 is arranged in the toothpaste chamber 5 of the electric toothbrush.

In the embodiments of the present disclosure, the specific structures of the electric toothbrush and the toothpaste bottle 7 may refer to those mentioned hereinabove, and thus will not be particularly defined herein. The health care device has all the beneficial effects of the above-mentioned electric toothbrush and toothpaste bottle 7.

For ease of understanding, the use of the health care device will be described hereinafter in conjunction with specific embodiments.

### First Embodiment

In this embodiment, the tooth brushing is performed by the user manually. To be specific, the first switch 91 is pressed and held by the user, and the first reader 53 reads the content stored in the first chip 71 (including the first serial number information) and transmits it to the control circuitry 3. The control circuitry 3 identifies the information in the first chip 71, e.g., the type of the toothpaste and the manufacturer, and when the toothpaste is genuine, the control circuitry 3 supplies power to the power generation device 6, so as to push the toothpaste continuously. When the first switch 91 is released, the control circuitry 3 stops supplying power to the power generation device 6, and the pushing of the toothpaste is stopped. When the amount of the extruded toothpaste meets the requirement, the pushing is stopped.

During the pushing of the toothpaste, the pushing state is indicated through the pushing state indicator. Different types of toothpaste may have different effects, e.g., caries prevention, breath freshening, teeth whitening, gingiva protection, teeth stain removal and anti-irritation. After the pushing, it needs to take a short time for preparation. Then, a working mode of the electric motor 12 is set in accordance with the efficacy mode information from the first chip 71 or the second chip 13, the mode indicator corresponding to the selected efficacy mode is always on, and the electric motor 12 is started to perform the tooth brushing. During the tooth brushing, a power-on slow vibration function is set, so that the electric motor 12 controls the vibration frequency of the toothbrush head 1 to increase slowly to a predetermined frequency after two seconds. When the toothpaste on the bristles is insufficient, the first switch 91 is pressed again to push the toothpaste.

When the toothpaste is non-genuine or there is no toothpaste, the pushing of the toothpaste is not started. At this time, the toothpaste is applied manually onto the toothbrush head 1, and then the second switch 92 is pressed to start the electric motor 12 for the tooth brushing. The toothpaste needs to be applied manually onto the toothbrush head at first. The efficacy mode information in the first chip 71 or the second chip 13 is read so as to set a tooth brushing mode. Of course, the efficacy mode information in the first chip 71 or the second chip 13 may not be read, and the tooth brushing is performed in a default mode.

### Second Embodiment

In this embodiment, the toothpaste is pushed by the user semi-automatically. To be specific, the first switch 91 is pressed by the user and held for a certain time period (short-pressed or long-pressed). The control circuitry 3 identifies the information in the first chip 71, e.g., the type of the toothpaste and the manufacturer, and when the toothpaste is genuine, it supplies power to the power generation device 6 so as to push the toothpaste continuously. During the pushing of the toothpaste, a pushing state is indicated through the pushing state indicator. The time for pushing of the toothpaste is determined by the information read from the first chip 71. After the pushing, it needs to take a short time for preparation for brushing teeth. Then, a working mode of the electric motor 12 is set in accordance with the efficacy mode information from the first chip 71 or the second chip 13, the mode indicator corresponding to the selected efficacy mode is always on, and the electric motor 12 is started to perform the tooth brushing. During the tooth brushing, a power-on slow vibration function is also set. When the toothpaste on the bristles is insufficient, the first switch 91 is pressed again to push the toothpaste.

The information in the first chip 71 includes the quantity of push-outs times within a predetermined time period, an alarm threshold, a push-out times threshold, time of multiple push-out, and the quantity of alarms. When the quantity of push-outs times within the predetermined time period reaches the alarm threshold, an alarm is sent by an indicator or a buzzer. However, at this time the toothpaste is pushed continuously. When the quantity of push-outs times within the predetermined time period reaches the push-out times threshold, an alarm is sent, but the toothpaste is not pushed any more.

Identically, when the toothpaste is non-genuine or there is no toothpaste, the pushing of the toothpaste is not started. At this time, the toothpaste is applied manually onto the toothbrush head 1, and then the second switch 92 is pressed for the tooth brushing.

When the first switch 91 is not pressed, the electric motor 12 is also started through directly pressing the second switch 92. At this time, the toothpaste needs to be applied manually onto the toothbrush head at first. The efficacy mode information in the first chip 71 is read so as to set a tooth brushing mode. Of course, the efficacy mode information in the first chip 71 may not be read, and the tooth brushing is performed in a default mode.

### Third Embodiment

In this example, the toothpaste is pushed automatically through the electric toothbrush. To be specific, the first switch 91 is pressed by the user. The control circuitry 3 identifies the information in the first chip 71, e.g., the type of the toothpaste and the manufacturer, and when the toothpaste is genuine, the control circuitry 3 supplies power to the power generation device 6, so as to push the toothpaste continuously. During the tooth brushing, the toothpaste is pushed one time or multiple times in accordance with the information in the first chip 71. During the pushing of the toothpaste, a pushing state is indicated through the pushing state indicator. The time for pushing of the toothpaste is determined by the information read from the first chip 71. After the pushing, it needs to take a short time for preparation. Then, a working mode of the electric motor 12 is set in accordance with the efficacy mode information from the first chip 71, the mode indicator corresponding to the selected efficacy mode is always on, and the electric motor 12 is started to perform the tooth brushing. During the tooth brushing, a power-on slow vibration function is also set. When the toothpaste on the bristles is insufficient, the first switch 91 is pressed again to push the toothpaste.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. An electric toothbrush, comprising a toothbrush head and a toothbrush handle detachably coupled to each other, wherein the toothbrush head comprises a first outlet, the toothbrush handle comprises an accommodation space in which a control circuitry, a connection device, a toothpaste chamber and a power generation device are provided, and the connection device is hollow,
wherein the toothpaste chamber comprises a second outlet and an accommodation cavity for accommodating a toothpaste bottle, the toothpaste bottle is provided with a first chip, first serial number information about the toothpaste bottle is stored in the first chip, the second outlet is in communication with the first outlet through the connection device, and the toothpaste chamber is provided with a first reader;
the power generation device is electrically coupled to the control circuitry, and configured to enable toothpaste in the toothpaste bottle to pass through the second outlet, the connection device and the first outlet to the toothbrush head; and
the first reader is configured to read the first serial number information from the first chip and transmit the first serial number information to the control circuitry, and the control circuitry is configured to receive the first serial number information and transmit a control signal to the power generation device in accordance with the first serial number information.

2. The electric toothbrush according to claim 1, wherein a first pipe and a propeller are further provided in the accommodation space, and the propeller is coupled to the power generation device through the first pipe and configured to push the toothpaste in the toothpaste bottle to the toothbrush head under the effect of a force applied by the power generation device.

3. The electric toothbrush according to claim 2, further comprising a first switch configured to control a working state of the power generation device through the control circuitry, wherein the first switch in a first state transmits a pushing signal to the control circuitry so that the control circuitry controls the power generation device to be in the working state in accordance with the pushing signal.

4. The electric toothbrush according to claim 3, wherein in the case that the first serial number information does not meet a first predetermined condition, the first switch is electrically decoupled from the control circuitry.

5. The electric toothbrush according to claim 1, further comprising an electric motor electrically coupled to the control circuitry and configured to drive the toothbrush head to vibrate.

6. The electric toothbrush according to claim 5, further comprising: a second chip arranged in the toothbrush head and configured to store therein second serial number information about the toothbrush head; and a second reader arranged at an end of the toothbrush handle close to the toothbrush head, and configured to read the second serial number information and transmit the second serial number information to the control circuitry, so that the control circuitry receives the second serial number information and controls a working state of the electric motor in accordance with the second serial number information.

7. The electric toothbrush according to claim 6, further comprising a second switch configured to control the working state of the electric motor through the control circuitry, wherein the second switch in a third state transmits a standby signal to the control circuitry so that the control circuitry controls the electric motor to be in a standby state in accordance with the standby signal,
wherein the case that the second serial number information does not meet a second predetermined condition, the second switch is electrically decoupled from the control circuitry.

8. (canceled)

9. The electric toothbrush according to claim 5, wherein a sensor assembly is further provided in the accommodation space and on an inner wall of the accommodation space, and electrically coupled to the control circuitry and the electric motor,
wherein the sensor assembly is configured to:
detect a pressure applied onto the toothbrush head in a direction perpendicular to a toothbrush surface;
in the case that a duration within which the detected pressure is greater than a first predetermined threshold is equal to a first predetermined duration, transmit a start signal to the control circuitry so that the control circuitry controls the electric motor to be in the working state in accordance with the start signal; and
in the case that a duration within which the detected pressure is smaller than a second predetermined threshold is equal to a second predetermined duration, transmit a third stop signal to the control circuitry so that the control circuitry controls the electric motor to be in a stopping state in accordance with the third stop signal,
wherein the sensor assembly comprises a first sensing element and a second sensing element, the first sensing element is arranged on the inner wall of the accommodation space, the second sensing element is arranged on the electric motor at a position opposite to the first sensing element, and a change in a distance between the first sensing element and the second sensing element is used to indicate the pressure applied onto the toothbrush head in the direction perpendicular to the toothbrush surface, and
wherein the first sensing element is one of a pressure sensor and a positioning unit, and the second sensing element is the other of the pressure sensor and the positioning unit; and/or the first sensing element is one of a Hall sensor and a magnet, and the second sensing element is the other of the Hall sensor and the magnet.

10.-11. (canceled)

12. The electric toothbrush according to claim 6, wherein the control circuitry is further configured to receive the second serial number information, and control a vibration frequency generated by the electric motor in accordance with the second serial number information, so that the vibration frequency generated by the electric motor corresponds to the toothpaste bottle.

13. The electric toothbrush according to claim 5, further comprising an electric motor cover plate fixedly coupled to the inner wall of the accommodation space and surrounding the electric motor.

14. The electric toothbrush according to claim 1, wherein a prompter is further arranged on the toothbrush handle, electrically coupled to the control circuitry, and configured to receive a prompt signal from the control circuitry and send an alarm.

15. The electric toothbrush according to claim 2, wherein the power generation device comprises an air pump coupled to the second outlet through the first pipe, and configured to inject air into the toothpaste chamber through the first pipe and the second outlet, so as to apply a force generated by the air onto the propeller,
wherein the electric toothbrush further comprises a signal detection circuitry coupled to the air pump and configured to transmit a fourth stop signal to the air pump in the case that an electric signal generated during the operation of the air pump is greater than a predetermined threshold, so as to enable the air pump to stop working.

16. The electric toothbrush according to claim 2, wherein the toothpaste chamber further comprises a second pipe comprising an air inlet and an air outlet, the air inlet forms the second outlet of the toothpaste chamber, and the propeller is arranged at the air outlet of the second pipe and forms a space surface of the accommodation cavity of the toothpaste bottle.

17. (canceled)

18. The electric toothbrush according to claim 5, wherein the toothbrush head comprises a cavity, a first end of the cavity is coupled to the first outlet, the connection device comprises a hollow transmission shaft and a conduit in communication with each other, the second outlet, the conduit, the hollow transmission shaft and the cavity are in communication with each other sequentially, the hollow transmission shaft is coupled to the electric motor, and the electric motor drives bristles of the toothbrush head to vibrate through the hollow transmission shaft,
wherein one-way valves are arranged between the conduit and the second outlet and between the first outlet and the hollow transmission shaft respectively, so as to allow the toothpaste to move in a direction from the toothpaste chamber to the toothbrush head.

19. (canceled)

20. A toothpaste bottle, comprising a container body and a first chip, the container body being provided with a liquid outlet, the first chip storing first serial number information about the toothpaste bottle, wherein the first chip is sleeved onto the liquid outlet of the container body and fixedly coupled to the container body, or the first chip is arranged on a side wall of the container body.

21. The toothpaste bottle according to claim 20, further comprising a sealing element, wherein the liquid outlet is arranged in the form of a protrusion, the sealing element is coupled to the liquid outlet, and the first chip is arranged between the sealing element and the container body.

22. The toothpaste bottle according to claim 21, further comprising a chip protection module sleeved onto the liquid outlet and arranged between the first chip and the sealing element,
wherein the chip protection module comprises a top cover and a side wall extending downward from an outer periphery of the top cover, an accommodation groove is defined by the top cover and the side wall, the first chip is arranged in the accommodation groove, and the sealing element is coupled to the top cover.

23. (canceled)

24. The toothpaste bottle according to claim 20, further comprising a base coupled to one end of the container body away from the liquid outlet.

25. The toothpaste bottle according to claim 24, further comprising a piston structure arranged inside the container body and comprising a fifth state in which the piston structure is attached to the base and a sixth state in which the piston structure is separated from the base,
wherein a ventilation module is arranged at a center of the base, protrudes from the base toward the piston structure, and is coupled to an external power generation device, wherein the piston structure is attached to the ventilation module in the case that a gas at a predetermined pressure is not applied by the power generation device onto the piston structure, so as to be in the fifth state, and the piston structure is separated from the ventilation module in the case that the gas at the predetermined pressure is applied by the power generation device onto the piston structure, so as to be in the sixth state.

26. (canceled)

27. The toothpaste bottle according to claim 20, wherein the first chip further stores at least one of a toothpaste type, a manufacturer, efficacy mode information, or toothpaste push-out information,
wherein the toothpaste push-out information comprises a quantity of push-out times within a predetermined time period, an alarm threshold, a push-out times threshold, time for multiple push-outs, and a quantity of alarms.

28.-29. (canceled)
